(19) United States
(12) Patent Application Publication
(10) Pub. No.: US 2022/0042192 A1
(43) Pub. Date: Feb. 10, 2022

(54) WATER ELECTROLYSIS SYSTEM

(71) Applicant: HONDA MOTOR CO., LTD., TOKYO (JP)

(72) Inventor: Naoki MITSUTA, WAKO-SHI (JP)

(21) Appl. No.: 17/392,624

(22) Filed: Aug. 3, 2021

(30) Foreign Application Priority Data
Aug. 6, 2020 (JP) 2020-133482

(51) Int. Cl. C25B 15/08; C25B 1/04; C25B 13/00; C25B 9/19; C25B 9/65

(52) U.S. Cl. CPC C25B 15/083; C25B 1/04; C25B 9/65; C25B 9/19; C25B 13/00

(57) ABSTRACT

A water electrolysis device of a water electrolysis system includes an ion exchange membrane, an anode, and a cathode. A water supply unit supplies water to the water electrolysis device. A power supply applies a voltage to the anode and the cathode. A water removal unit separates water from the hydrogen gas discharged from the cathode. An electrochemical hydrogen compressor boosts the pressure of hydrogen gas. An oxygen gas discharge regulating unit makes the pressure of the oxygen gas generated in the anode higher than the pressure of the hydrogen gas generated in the cathode.

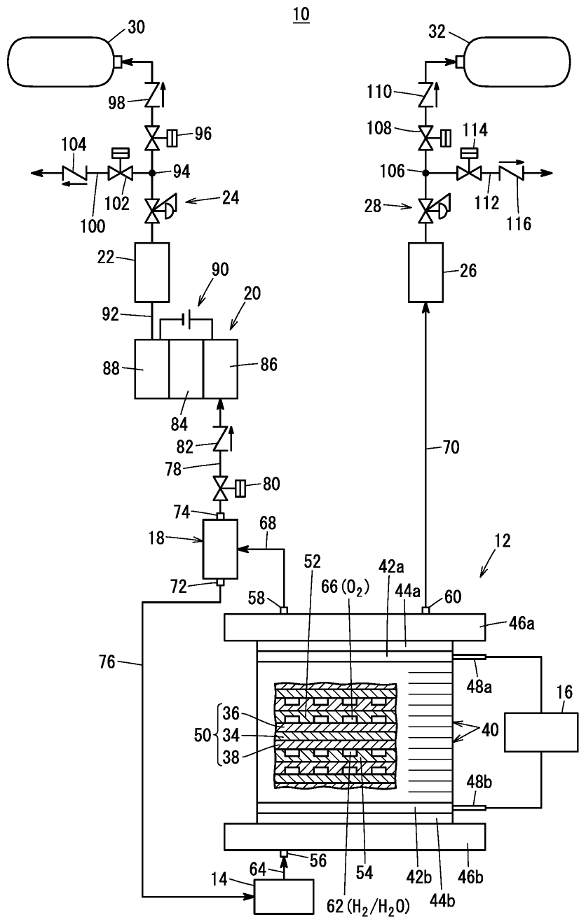

### CROSS-REFERENCE TO RELATED APPLICATION

This application is based upon and claims the benefit of priority from Japanese Patent Application No. 2020-133482 filed on Aug. 6, 2020, the contents of which are incorporated herein by reference.

### BACKGROUND OF THE INVENTION

### Field of the Invention

The present invention relates to a water electrolysis system.

### Description of the Related Art

In general, in a power generation reaction of a fuel cell mounted on a fuel cell vehicle or the like, hydrogen gas is used as a fuel gas. Oxygen gas (oxygen-containing gas) is used as an oxygen-containing gas. Hydrogen gas can be produced by a water electrolysis system including a water electrolysis device. That is, in the water electrolysis system, by electrolyzing water by the water electrolysis device, hydrogen gas can be generated at the cathode of the water electrolysis device. At this time, oxygen gas is generated at the anode of the water electrolysis device. This oxygen gas can also be effectively used as an oxygen-containing gas, for example. That is, by supplying the oxygen gas to the fuel cell, the power generation reaction can be favorably caused even in a place where the oxygen partial pressure or the oxygen concentration is low (for example, a high place or a space). Therefore, in the water electrolysis system, it is preferable to recover both hydrogen gas and oxygen gas generated in the water electrolysis device.

As a water electrolysis device, for example, as disclosed in JP H09-139217 A, a solid polymer type device capable of operating at a relatively high current density is known. This type of water electrolysis device has an electrolyte membrane electrode assembly configured by providing an electrode catalyst layer and a current collector on each of both surfaces of an ion exchange membrane serving as an electrolyte. The electrode catalyst layer and the current collector provided on one surface of the ion exchange membrane constitute an anode. The electrode catalyst layer and the current collector provided on the other surface of the ion exchange membrane constitute a cathode. The anode and the cathode are separated from each other by the ion exchange membrane.

### SUMMARY OF THE INVENTION

In the above-described water electrolysis device, there is a concern that a so-called crossover occurs in which at least one of the oxygen gas and the hydrogen gas permeates through the ion exchange membrane. In particular, since the molecular weight of hydrogen gas is smaller than that of oxygen gas, hydrogen gas easily enters the anode from the cathode through the ion exchange membrane. However, the water electrolysis system is required to produce hydrogen gas and oxygen gas in a state of being separated from each other.

An object of the present invention is to solve the above-described problems.

According to an aspect of the present invention, there is provided a water electrolysis system including a water electrolysis device having an anode and a cathode which are disposed so as to interpose an ion exchange membrane therebetween and are isolated from each other, the water electrolysis device being configured to electrolyze water to thereby generate oxygen gas in the anode and generate hydrogen gas in the cathode, the water electrolysis system including: a water supply unit configured to supply water to the water electrolysis device; a power supply configured to apply a voltage to the anode and the cathode; a water removal unit configured to separate water from the hydrogen gas discharged from the cathode; an electrochemical hydrogen compressor configured to boost a pressure of the hydrogen gas from which the water has been separated by the water removal unit; and an oxygen gas discharge regulating unit configured to regulate discharge of the oxygen gas generated in the anode, so that a pressure of the oxygen gas generated in the anode is higher than a pressure of the hydrogen gas generated in the cathode.

In this water electrolysis system, the oxygen gas discharge regulating unit causes the pressure of the oxygen gas at the anode to be higher than the pressure of the hydrogen gas at the cathode. This prevents hydrogen gas from permeating through the ion exchange membrane from the low-pressure cathode toward the high-pressure anode. That is, the directionality (crossover directionality) in the case where the gas passes through the ion exchange membrane is fixed to (set to) the direction from the anode to the cathode. Therefore, the hydrogen gas generated at the cathode can be prevented from entering the anode side.

When the directionality of the crossover is not fixed, it is necessary to cope with both the hydrogen gas entering the anode and the oxygen gas entering the cathode. On the other hand, by fixing the directionality of the crossover as described above, it becomes possible to focus on the handling of the oxygen gas entering the cathode. As a result, it becomes easy to produce hydrogen gas and oxygen gas in a state of being well separated from each other.

Moreover, oxygen gas having a larger molecular weight than hydrogen gas is less likely to permeate the ion exchange membrane than hydrogen gas. Therefore, even if the directionality of the crossover is fixed as described above, it is possible to avoid a significant increase in the amount of oxygen gas permeating through the ion exchange membrane from the anode toward the cathode. The solubility of oxygen gas in water is higher than that of hydrogen gas. Therefore, even if the oxygen gas generated at the anode permeates through the ion exchange membrane, the oxygen gas can be dissolved in the water present at the cathode or the like of the water electrolysis device. Thus, it also becomes easy to produce hydrogen gas and oxygen gas in a state of being well separated from each other.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIGURE of drawing is a schematic configuration explanatory diagram of a water electrolysis system according to an embodiment of the present invention.

### DESCRIPTION OF THE PREFERRED EMBODIMENTS

As shown in FIGURE of drawing, a water electrolysis system 10 according to the present embodiment mainly includes a water electrolysis device 12, a water supply unit 14, a power supply 16, a water removal unit 18, an electrochemical hydrogen compressor 20, a hydrogen gas dehumidifying unit 22, a hydrogen gas discharge regulating unit 24, an oxygen gas dehumidifying unit 26, an oxygen gas discharge regulating unit 28, and a control unit (not shown). Various controls of the water electrolysis device 12 can be performed by a control unit. The control unit is configured as a computer including a CPU, a memory, and the like (not shown).

The water electrolysis system 10 can produce the hydrogen gas in a state of high-pressure hydrogen gas compressed to 1 to 100 MPa, for example. In addition, the water electrolysis system 10 can produce an oxygen gas in a state of a high-pressure oxygen gas compressed to 1 to 100 MPa, for example. The high-pressure hydrogen gas produced by the water electrolysis system 10 can be stored in, for example, a hydrogen gas tank 30. The hydrogen gas tank 30 is detachably attached to the water electrolysis system 10. The high-pressure oxygen gas produced by the water electrolysis system 10 can be stored in, for example, an oxygen gas tank 32. The oxygen gas tank 32 is detachably attached to the water electrolysis system 10.

The water electrolysis device 12 has an ion exchange membrane 34, which is an electrolyte. The water electrolysis device 12 includes an anode 36 and a cathode 38 which are disposed with an ion exchange membrane 34 interposed therebetween and are isolated from each other. The water electrolysis device 12 electrolyzes water (water electrolysis) to thereby generate oxygen gas at the anode 36. The water electrolysis device 12 electrolyzes water (water electrolysis) to thereby generate hydrogen gas at the cathode 38. That is, the water electrolysis device 12 is a so-called solid polymer type.

In the present embodiment, the water electrolysis device 12 includes a cell unit in which a plurality of unit cells 40 are stacked. A terminal plate 42a, an insulating plate 44a, and an end plate 46a are sequentially disposed outward at one end, in the stacking direction of the unit cell 40, of the cell unit. Further, a terminal plate 42b, an insulating plate 44b, and an end plate 46b are disposed outward, in this order, at the other end, in the stacking direction of the unit cell 40, of the cell unit.

The components between the end plates 46a and 46b are integrally clamped and held by tightening. On side portions of the terminal plates 42a and 42b, terminal portions 48a and 48b are provided so as to protrude outward. A power supply 16 is electrically connected to the terminal portions 48a and 48b via wirings. The power supply 16 can apply a voltage to the anode 36 and the cathode 38 of the water electrolysis device 12 via the terminal portions 48a and 48b.

Each unit cell 40 includes a membrane electrode assembly 50 (MEA), an anode-side separator 52, and a cathode-side separator 54. Each of the membrane electrode assembly 50, the anode-side separator 52, and the cathode-side separator 54 has, for example, a disk shape. The membrane electrode assembly 50 is sandwiched between the anode-side separator 52 and the cathode-side separator 54. The membrane electrode assembly 50 includes an ion exchange membrane 34, an anode 36, and a cathode 38. The anode 36 is provided on one surface of the ion exchange membrane 34. The cathode 38 is provided on the other surface of the ion exchange membrane 34. In each unit cell 40, the anode 36 and the cathode 38 are sealed (isolated) from each other by the ion exchange membrane 34 and, for example, a sealing member (not shown).

In the present embodiment, the ion exchange membrane 34 is an anion exchange membrane. That is, the ion exchange membrane 34 has anion conductivity capable of selectively moving anions (for example, hydroxide ions OH⁻). An example of this type of ion exchange membrane 34 includes a hydrocarbon-based solid polymer membrane (for example, polystyrene or a modified product thereof) having an anion exchange group (for example, a quaternary ammonium group or a pyridinium group).

The anode 36 includes an anode electrode catalyst layer and an anode-side current collector (both not shown). The anode electrode catalyst layer is formed on one surface of the ion exchange membrane 34. The anode-side current collector is stacked on the anode electrode catalyst layer. The cathode 38 includes a cathode electrode catalyst layer and a cathode-side current collector (both not shown). The cathode electrode catalyst layer is formed on the other surface of the ion exchange membrane 34. The cathode-side current collector is stacked on the cathode electrode catalyst layer.

A water supply communication hole 56, a hydrogen discharge communication hole 58, and an oxygen discharge communication hole 60 are provided in an outer peripheral portion of each unit cell 40. The water supply communication holes 56 provided in the plurality of unit cells 40 communicate with each other in the stacking direction of the plurality of unit cells 40. The hydrogen discharge communication holes 58 provided in the plurality of unit cells 40 communicate with each other in the stacking direction of the plurality of unit cells 40. The oxygen discharge communication holes 60 provided in the plurality of unit cells 40 communicate with each other in the stacking direction of the plurality of unit cells 40. The water supply communication hole 56 and the hydrogen discharge communication hole 58 communicate with the first cell flow path 62. On a surface of the cathode-side separator 54 that faces the membrane electrode assembly 50 (cathode-side current collector), for example, at least a plurality of flow grooves or a plurality of bosses are formed. The first cell flow path 62 is formed of, for example, at least the plurality of flow path grooves or the plurality of bosses on the cathode-side separator 54.

Water is supplied from the water supply unit 14 to the water supply communication hole 56 via the water supply flow path 64. The water supplied to the water supply communication hole 56 flows into the first cell flow path 62, whereby the water is supplied to the cathode 38 of each unit cell 40. That is, in the water electrolysis device 12 of the present embodiment, water is supplied to the cathode 38 side of each unit cell 40. When this water is subjected to water electrolysis under voltage application by the power supply 16, hydrogen gas is generated at the cathode 38 of each unit cell 40. Oxygen gas is generated at the anode 36 of each unit cell 40.

The hydrogen gas generated in the cathode 38 is discharged to the hydrogen discharge communication hole 58 via the first cell flow path 62. The hydrogen gas thus discharged to the hydrogen discharge communication hole 58 contains excess water (unreacted water) that has not been subjected to water electrolysis in the water electrolysis device 12. In other words, the discharged fluid discharged to the hydrogen discharge communication hole 58 contains hydrogen gas, liquid unreacted water (liquid water), and gaseous unreacted water (water vapor).

The oxygen discharge communication hole 60 communicates with the second cell flow path 66. On a surface of the anode-side separator 52 that faces the membrane electrode assembly 50 (anode-side current collector), for example, at least a plurality of flow channels or a plurality of bosses are formed. For example, the second cell flow path 66 is configured by at least the plurality of flow path grooves or the plurality of bosses in the anode-side separator 52. The oxygen gas generated in the anode 36 by the water electrolysis is discharged to the oxygen discharge communication hole 60 through the second cell flow path 66.

In the water electrolysis device 12, the water supply flow path 64 communicates with the water supply communication hole 56 as described above. A cathode discharge flow path 68 communicates with the hydrogen discharge communication hole 58. The anode discharge flow path 70 communicates with the oxygen discharge communication hole 60.

The cathode discharge flow path 68 is provided with the water removal unit 18. In the present embodiment, the water removal unit 18 is made up of a gas-liquid separator. The above-described discharged fluid flows into the water removal unit 18 through the hydrogen discharge communication hole 58 and the cathode discharge flow path 68. The water removal unit 18 separates the discharged fluid into a gas component (hydrogen gas and water vapor) and a liquid component (liquid water). The water removal unit 18 has a liquid discharge port 72 for discharging liquid water and a gas discharge port 74 for discharging hydrogen gas containing water vapor. The liquid water discharged from the liquid discharge port 72 is sent to the water supply unit 14 via the circulation flow path 76, for example.

The water supply unit 14 of the present embodiment includes a pure water generation unit, a circulation pump, and an ion exchanger, which are not illustrated. The pure water generation unit generates pure water from, for example, tap water. Liquid water (unreacted water) is sent from the liquid discharge port 72 to the circulation pump of the water supply unit 14 via the circulation flow path 76. The circulation pump sends the liquid water (unreacted water) to the cathode 38 (water supply communication hole 56) of the water electrolysis device 12 together with the pure water generated in the pure water generation unit. The ion exchanger removes impurities from water (unreacted water, pure water) before being supplied to the water supply communication hole 56. The water supply unit 14 is not limited to one having the above-described configuration as long as it can supply water to the cathode 38 of the water electrolysis device 12.

The gas discharge port 74 of the water removal unit 18 communicates with the first hydrogen gas flow path 78. The first hydrogen gas flow path 78 guides the hydrogen gas containing water vapor discharged from the gas discharge port 74 to the electrochemical hydrogen compressor 20. The first hydrogen gas flow path 78 has an upstream side where the gas discharge port 74 is provided and a downstream side where the electrochemical hydrogen compressor 20 is provided. In the first hydrogen gas flow path 78, a first hydrogen on-off valve 80 and a first hydrogen check valve 82 are provided in this order from the upstream side toward the downstream side. The first hydrogen on-off valve 80 is formed of, for example, a solenoid valve or an electric valve. The first hydrogen on-off valve 80 opens and closes the first hydrogen gas flow path 78 under the control of the control unit. The first hydrogen check valve 82 prevents the gas in the first hydrogen gas flow path 78 from flowing in a direction from the electrochemical hydrogen compressor 20 toward the gas discharge port 74.

The electrochemical hydrogen compressor 20 boosts the pressure of the hydrogen gas containing water vapor discharged from the gas discharge port 74. That is, the electrochemical hydrogen compressor 20 increases the pressure of the hydrogen gas from which liquid water has been separated by the water removal unit 18. In the present embodiment, the electrochemical hydrogen compressor 20 includes a booster proton exchange membrane 84, a booster anode 86, a booster cathode 88, and a booster power supply 90. The booster anode 86 and the booster cathode 88 are disposed with the booster proton exchange membrane 84 interposed therebetween, and are isolated from each other. The booster power supply 90 applies a voltage to the booster anode 86 and the booster cathode 88.

The booster proton exchange membrane 84 has proton conductivity capable of selectively moving protons. The material of the booster proton exchange membrane 84 is not particularly limited, but an example thereof includes a fluorine-based polymer membrane having a sulfonic acid group such as a perfluorosulfonic acid-based polymer. The booster proton exchange membrane 84 of this type can exhibit excellent proton conductivity by being kept in a wet state.

Although not shown, the booster anode 86 includes a booster anode electrode catalyst layer and a booster anode gas diffusion layer. The booster anode electrode catalyst layer is formed on one surface of the booster proton exchange membrane 84. The booster anode gas diffusion layer is stacked on the booster anode electrode catalyst layer. The booster cathode 88 has a booster cathode electrode catalyst layer and a booster cathode gas diffusion layer, neither of which is shown. The booster cathode electrode catalyst layer is formed on the other surface of the booster proton exchange membrane 84. The booster cathode gas diffusion layer is stacked on the booster cathode electrode catalyst layer.

The hydrogen gas containing water vapor discharged from the gas discharge port 74 is supplied to the booster anode 86 via the first hydrogen gas flow path 78. The water vapor can be used to keep the booster proton exchange membrane 84 in a wet state. In the booster anode 86, the hydrogen gas is ionized into protons under voltage application by the booster power supply 90. The protons move through the booster proton exchange membrane 84 and reach the booster cathode 88, whereby the protons return to hydrogen gas. By moving protons from the booster anode 86 toward the booster cathode 88 in this manner, compressed hydrogen gas can be generated in the booster cathode 88.

Therefore, according to the electrochemical hydrogen compressor 20, the hydrogen gas having a higher pressure than the hydrogen gas supplied to the booster anode 86 can be discharged from the booster cathode 88. That is, the electrochemical hydrogen compressor 20 of the present embodiment includes an electrochemical hydrogen compressor (EHC) configured to electrochemically compress hydrogen gas.

The booster cathode 88 communicates with one end portion of the second hydrogen gas flow path 92. Thus, the hydrogen gas in the booster cathode 88 can flow into the second hydrogen gas flow path 92. A tank mounting mechanism (not shown) is provided at the other end of the second hydrogen gas flow path 92. The hydrogen gas tank 30 is detachably attached to the second hydrogen gas flow path 92 via the tank attachment mechanism. That is, the second hydrogen gas flow path 92 guides the hydrogen gas from the upstream side where the booster cathode 88 is provided toward the downstream side where the hydrogen gas tank 30 is provided.

In the second hydrogen gas flow path 92, a hydrogen gas dehumidifying unit 22, a hydrogen gas discharge regulating unit 24, a hydrogen purge flow path branch portion 94, a second hydrogen on-off valve 96, and a second hydrogen check valve 98 are provided in this order from upstream to downstream.

The hydrogen gas dehumidifying unit 22 dehumidifies the hydrogen gas discharged from the booster cathode 88. That is, the hydrogen gas dehumidifying unit 22 separates water vapor from the hydrogen gas. An example of the hydrogen gas dehumidifying unit 22 includes a cooling mechanism (not shown) such as a Peltier cooler. In this case, the hydrogen gas is cooled by the cooling mechanism to reduce the amount of saturated water vapor, whereby moisture (water vapor) contained in the hydrogen gas can be separated to thereby obtain a desired dry state. In this case, the control unit may control the cooling temperature by the cooling mechanism according to at least one of the ambient temperature of the water electrolysis system 10 and the pressure of the hydrogen gas, for example.

In addition, as another example of the hydrogen gas dehumidifying unit 22, a moisture adsorbent such as a zeolite-based moisture adsorbent, an activated carbon-based moisture adsorbent, or a silica gel-based moisture adsorbent may be used instead of the cooling mechanism or together with the cooling mechanism. Note that the moisture adsorbent may be a paste-like moisture getter agent or the like that can be used by being applied to a portion to be coated. In this case, the hydrogen gas dehumidifying unit 22 may be configured to regenerate the moisture adsorbent by at least one of a temperature swing adsorption method (TSA) and a pressure swing adsorption method (PSA), for example. In addition, the hydrogen gas dehumidifying unit 22 may include, for example, only a configuration in which the moisture adsorbent is replaceable. The specific configuration of the hydrogen gas dehumidifying unit 22 is not limited to that described above as long as the hydrogen gas dehumidifying unit 22 can dehumidify the hydrogen gas.

The hydrogen gas discharge regulating unit 24 regulates the passage of hydrogen gas through the hydrogen gas discharge regulating unit 24. Accordingly, the hydrogen gas discharge regulating unit 24 adjusts the pressure of the hydrogen gas in the second hydrogen gas flow path 92. That is, for example, the hydrogen gas discharge regulating unit 24 reduces the passage amount of the hydrogen gas in the hydrogen gas discharge regulating unit 24 to be smaller than the generation amount of the hydrogen gas in the booster cathode 88 (including the passage amount of zero). As a result, the pressure of the hydrogen gas in the second hydrogen gas flow path 92 can be increased to thereby obtain high-pressure hydrogen gas.

In the present embodiment, the hydrogen gas discharge regulating unit 24 is a back pressure valve that opens while maintaining the pressure on the primary side (upstream of the hydrogen gas discharge regulating unit 24 in the second hydrogen gas flow path 92) at a set pressure. However, the present invention is not particularly limited thereto. For example, the hydrogen gas discharge regulating unit 24 may be an on-off valve or the like that maintains the pressure of the second hydrogen gas flow path 92 at a set pressure by being controlled to be opened and closed by the control unit.

The hydrogen gas discharge regulating unit 24 generates high-pressure hydrogen gas by adjusting the hydrogen-gas pressure in the second hydrogen gas flow path 92 to 1 to 100 MPa. For example, from the viewpoint of facilitating the supply of the hydrogen gas to the hydrogen gas tank 30, it is preferable that the hydrogen gas discharge regulating unit 24 sets the pressure of the high-pressure hydrogen gas to at least 8 to 20 MPa. In addition, for example, in a case where the hydrogen gas is supplied to the hydrogen gas tank 30 or the like for the fuel-cell vehicle, the hydrogen gas discharge regulating unit 24 preferably sets the pressure of the high-pressure hydrogen gas to 70 to 85 MPa or more.

The hydrogen purge flow path branch portion 94 is a connection point between the second hydrogen gas flow path 92 and the hydrogen purge flow path 100. The hydrogen purge flow path 100 enables a degassing (reduction in pressure) operation in the water electrolysis system 10 to be performed, for example, when the water electrolysis system 10 is stopped. The hydrogen purge flow path 100 guides the hydrogen gas that has flowed thereinto from the hydrogen purge flow path branch portion 94, to the outside of the water electrolysis system 10. In the hydrogen purge flow path 100, a hydrogen purge on-off valve 102 and a hydrogen purge check valve 104 are provided in this order from the upstream side toward the downstream side.

The hydrogen purge on-off valve 102 is formed of, for example, a solenoid valve or an electric valve. The hydrogen purge on-off valve 102 opens and closes the hydrogen purge flow path 100 under the control of the control unit. When the hydrogen purge on-off valve 102 is in a closed state, hydrogen gas is prevented from flowing into the hydrogen purge flow path 100 from the second hydrogen gas flow path 92. When the hydrogen purge on-off valve 102 is in an open state, hydrogen gas flows from the second hydrogen gas flow path 92 into the hydrogen purge flow path 100. The hydrogen gas flowing into the hydrogen purge flow path 100 is discharged to the outside of the water electrolysis system 10. The hydrogen purge check valve 104 prevents gas from flowing into the hydrogen purge flow path 100 from the outside of the water electrolysis system 10.

The second hydrogen on-off valve 96 is, for example, a solenoid valve or an electric valve. The second hydrogen on-off valve 96 opens and closes the second hydrogen gas flow path 92 under the control of the control unit. By opening the second hydrogen on-off valve 96, hydrogen gas can be supplied from the second hydrogen gas flow path 92 to the hydrogen gas tank 30. The second hydrogen check valve 98 prevents hydrogen gas from flowing back in a direction from the hydrogen gas tank 30 toward the upstream side (the second hydrogen on-off valve 96) of the second hydrogen gas flow path 92.

One end of the anode discharge flow path 70 communicates with the oxygen discharge communication hole 60 of the water electrolysis device 12 as described above. Therefore, the oxygen gas generated in the anode 36 of the water electrolysis device 12 can flow into the anode discharge flow path 70. A tank mounting mechanism (not shown) or the like is provided at the other end of the anode discharge flow path 70, and the oxygen gas tank 32 is detachably mounted via the tank mounting mechanism. That is, the anode discharge flow path 70 guides the oxygen gas in a direction from the oxygen discharge communication hole 60 (upstream) toward the oxygen gas tank 32 (downstream). In the anode discharge flow path 70, an oxygen gas dehumidifying unit 26, an oxygen gas discharge regulating unit 28, an oxygen purge flow path branch portion 106, an oxygen on-off valve 108, and an oxygen check valve 110 are provided in this order from the upstream side toward the downstream side.

The oxygen gas dehumidifying unit 26 dehumidifies the oxygen gas discharged from the anode 36 (oxygen discharge communication hole 60) of the water electrolysis device 12. The oxygen gas dehumidifying unit 26 can be configured in the same manner as the hydrogen gas dehumidifying unit 22 described above, for example. However, the specific configuration of the oxygen gas dehumidifying unit 26 is not particularly limited as long as the oxygen gas dehumidifying unit 26 can dehumidify the oxygen gas.

The oxygen gas discharge regulating unit 28 regulates the passage of oxygen gas through the oxygen gas discharge regulating unit 28. In this way, the oxygen gas discharge regulating unit 28 regulates the discharge of oxygen gas from the anode 36. Specifically, for example, the oxygen gas discharge regulating unit 28 reduces the passage amount of oxygen gas passing through the oxygen gas discharge regulating unit 28 to be smaller than the generation amount of oxygen gas generated in the anode 36 (including the passing amount of zero). Thus, the pressure of the oxygen gas at the anode 36 is increased to be higher than the pressure of the hydrogen gas at the cathode 38. That is, a differential pressure is generated between the anode 36 and the cathode 38 of the water electrolysis device 12. In addition, the pressure of the oxygen gas in the anode discharge flow path 70 is increased to thereby generate high-pressure oxygen gas.

In the present embodiment, the oxygen gas discharge regulating unit 28 is a back pressure valve that opens while maintaining the pressure of the oxygen gas on the primary side (anode 36, anode discharge flow path 70) at a set pressure. However, the present invention is not particularly limited thereto. For example, the oxygen gas discharge regulating unit 28 may be an on-off valve or the like that maintains the pressure of the anode 36 and the pressure of the high-pressure oxygen gas at a set pressure by being controlled to be opened and closed by the control unit.

The oxygen gas discharge regulating unit 28 regulates the oxygen-gas pressure of the anode 36 to 1 to 100 MPa. As a result, the oxygen gas discharge regulating unit 28 sets the pressure of the oxygen gas of the anode 36 to be higher than the pressure of the hydrogen gas of the cathode 38. That is, during the operation of the water electrolysis system 10, the pressure of the hydrogen gas in the cathode 38 (the cathode discharge flow path 68 and the first hydrogen gas flow path 78) is maintained at less than 1 MPa (for example, 0.01 to 0.9 MPa).

An example of a method for maintaining the pressure of the hydrogen gas in the cathode 38 includes setting the flow rate of the hydrogen gas passing through the cathode discharge flow path 68, the water removal unit 18, and the first hydrogen gas flow path 78 to be sufficiently large in relation to the generation amount of hydrogen gas generated in the cathode 38. In addition, the generation amount of hydrogen gas in the booster cathode 88 may be set sufficiently large in relation to the generation amount of hydrogen gas generated in the cathode 38.

In the case where water is supplied to the cathode 38 at the hydrogen gas pressure of 0.01 to 0.9 MPa as described above, the water pressures of the water supply flow path 64 and the circulating flow path 76 are set to 0.01 to 0.6 MPa, for example.

For example, from the viewpoint of facilitating the supply of the oxygen gas to the oxygen gas tank 32, it is preferable that the oxygen gas discharge regulating unit 28 sets the pressure of the high-pressure oxygen gas to at least 8 to 20 MPa or more. In addition, the oxygen gas discharge regulating unit 28 preferably sets the pressure of the high-pressure oxygen gas to 30 to 40 MPa from the viewpoint of increasing the amount of the oxygen gas contained in the oxygen gas tank 32 as much as possible within a range in which handling of the oxygen gas is not difficult.

The oxygen purge flow path branch portion 106 is a connection point between the anode discharge flow path 70 and the oxygen purge flow path 112. The oxygen purge flow path 112 enables a degassing (reduction in pressure) operation in the water electrolysis system 10 to be performed, for example, when the water electrolysis system 10 is stopped. The oxygen purge flow path 112 guides the oxygen gas that has flowed thereinto from the oxygen purge flow path branch portion 106, to the outside of the water electrolysis system 10. In the oxygen purge flow path 112, an oxygen purge on-off valve 114 and an oxygen purge check valve 116 are provided in this order from the upstream side toward the downstream side.

The oxygen purge on-off valve 114 is formed of, for example, a solenoid valve or an electric valve. The oxygen purge on-off valve 114 opens and closes the oxygen purge flow path 112 under the control of the control unit. When the oxygen purge on-off valve 114 is in the closed state, oxygen gas is prevented from flowing into the oxygen purge flow path 112 from the anode discharge flow path 70. When the oxygen purge on-off valve 114 is in the open state, oxygen gas flows from the anode discharge flow path 70 into the oxygen purge flow path 112. The oxygen gas flowing into the oxygen purge flow path 112 is discharged to the outside of the water electrolysis system 10. The oxygen purge check valve 116 prevents gas from flowing into the oxygen purge flow path 112 from the outside of the water electrolysis system 10.

The oxygen on-off valve 108 is formed of, for example, a solenoid valve or an electric valve. The oxygen on-off valve 108 opens and closes the anode discharge flow path 70 under the control of the control unit. By opening the oxygen on-off valve 108, the oxygen gas can be supplied from the anode discharge flow path 70 to the oxygen gas tank 32. The oxygen check valve 110 prevents oxygen gas from flowing back in a direction from the oxygen gas tank 32 toward the upstream side (the oxygen on-off valve 108) of the anode discharge flow path 70.

The water electrolysis system 10 according to the present embodiment is basically configured as described above. An example of a control method when the water electrolysis system 10 is activated to produce hydrogen gas and oxygen gas will be described.

In this control method, the water supply step is performed after the water electrolysis system 10 is started up and various statuses thereof are confirmed. In the water supply step, water is supplied from the water supply unit 14 to the water supply communication hole 56 of the water electrolysis device 12 via the water supply flow path 64. Thus, water is supplied to the cathode 38 of the water electrolysis device 12.

Next, a voltage application step of applying a voltage to the water electrolysis device 12 by the power supply 16 is performed. In the voltage application step, the voltage between the anode 36 and the cathode 38 is maintained as a standby voltage in the vicinity of an electrolysis voltage until the water electrolysis device 12 is in a state capable of generating each of hydrogen gas and oxygen gas. Then, after the water electrolysis device 12 is in a state capable of generating each of the hydrogen gas and the oxygen gas, the voltage between the anode 36 and the cathode 38 is increased to the electrolysis voltage, thereby starting water electrolysis. Thus, a water electrolysis step is performed in which hydrogen gas is generated in the cathode 38 of the water electrolysis device 12 and oxygen gas is generated in the anode 36.

Hereinafter, a process of filling the hydrogen gas tank 30 with the hydrogen gas generated at the cathode 38 in the water electrolysis process will be described.

The hydrogen gas generated at the cathode 38 in the water electrolysis step is discharged as a discharged fluid containing unreacted water (liquid water and water vapor) from the hydrogen discharge communication hole 58 of the water electrolysis device 12 to the cathode discharge flow path 68. The discharged fluid discharged to the cathode discharge flow path 68 is sent to the water removal unit 18. The water removal unit 18 performs a water separation step of separating the discharged fluid into liquid water as a liquid component and hydrogen gas and water vapor as gas components.

The liquid water separated in the water separation step is discharged from the liquid discharge port 72 of the water removal unit 18 to the circulation flow path 76. The liquid water discharged to the circulation flow path 76 is sent to the water supply unit 14. The water supply unit 14 supplies the liquid water sent via the circulation flow path 76 to the cathode 38 via the water supply flow path 64 and the water supply communication hole 56 together with the pure water generated in the water supply unit 14.

On the other hand, the hydrogen gas and the water vapor separated in the water separation step are discharged from the gas discharge port 74 of the water removal unit 18 to the first hydrogen gas flow path 78. When the water electrolysis system 10 is started, the first hydrogen on-off valve 80 is opened. Therefore, the hydrogen gas and the water vapor discharged to the first hydrogen gas flow path 78 pass through the first hydrogen on-off valve 80 and then further pass through the first hydrogen check valve 82. The hydrogen gas and the water vapor that have passed through the first hydrogen check valve 82 are supplied to the booster anode 86 of the electrochemical hydrogen compressor 20. At this time, the first hydrogen check valve 82 prevents the hydrogen gas from flowing back from the electrochemical hydrogen compressor 20 toward the first hydrogen on-off valve 80.

When the supply of the hydrogen gas to the booster anode 86 is confirmed, the electrochemical hydrogen compressor 20 starts the application of the operating voltage by the booster power supply 90. The operating voltage has such a magnitude that compressed hydrogen gas can be generated in the booster cathode 88 by applying the operating voltage between the booster anode 86 and the booster cathode 88. That is, the electrochemical hydrogen compressor 20 performs the hydrogen gas boosting step of boosting the pressure of the hydrogen gas by applying the operating voltage from the booster power supply 90.

As an example of a method for confirming that the hydrogen gas has been supplied to the booster anode 86, a pressure sensor (not shown) is provided in the booster anode 86. The control unit compares the measurement value of the pressure sensor with a predetermined threshold value. When the measurement value of the pressure sensor exceeds the predetermined threshold value, the control unit determines that hydrogen gas has been supplied to the booster anode 86.

The hydrogen gas generated in the booster cathode 88 by the hydrogen gas boosting step is discharged to the second hydrogen gas flow path 92, and is dehumidified by the hydrogen gas dehumidifying unit 22 provided in the second hydrogen gas flow path 92. That is, the hydrogen gas dehumidifying unit 22 performs a hydrogen gas dehumidifying step of removing water vapor contained in the hydrogen gas discharged from the booster cathode 88.

The hydrogen gas discharge regulating unit 24 provided at the subsequent stage of the hydrogen gas dehumidifying unit 22 of the second hydrogen gas flow path 92 performs a hydrogen gas pressure adjusting step of adjusting the pressure of the hydrogen gas in the second hydrogen gas flow path 92. In the hydrogen gas pressure adjusting step, for example, the pressure of the hydrogen gas in the second hydrogen gas flow path 92 is adjusted by adjusting the passage amount of the hydrogen gas passing through the hydrogen gas discharge regulating unit 24 with respect to the generation amount of the hydrogen gas generated in the booster cathode 88.

In the present embodiment, the hydrogen gas discharge regulating unit 24 is a back pressure valve. Thus, the hydrogen gas discharge regulating unit 24 opens the valve while maintaining the hydrogen-gas pressure on the primary side (upstream side) when the hydrogen-gas pressure on the primary side rises and reaches a set pressure set within a range of 1 to 100 MPa, for example. As a result, the high-pressure hydrogen gas boosted to the set pressure can be supplied to the secondary side (downstream) of the hydrogen gas discharge regulating unit 24.

When the water electrolysis system 10 is started, the hydrogen purge on-off valve 102 is closed. When the water electrolysis system 10 is started, the second hydrogen on-off valve 96 is opened. Therefore, the high-pressure hydrogen gas whose pressure has been adjusted to the set pressure in the hydrogen gas pressure adjusting step does not flow into the hydrogen purge flow path 100, but passes through the second hydrogen on-off valve 96 and the second hydrogen check valve 98 and then fills the hydrogen gas tank 30. At this time, the second hydrogen check valve 98 prevents the hydrogen gas from flowing back in the direction from the hydrogen gas tank 30 toward the second hydrogen on-off valve 96.

As described above, in the water electrolysis system 10, the hydrogen gas generated at the cathode 38 of the water electrolysis device 12 is boosted in pressure by the electrochemical hydrogen compressor 20 to thereby produce the high-pressure hydrogen gas, and the hydrogen gas tank 30 can be filled with the high-pressure hydrogen gas. During the operation of the water electrolysis system 10, the hydrogen gas is maintained at a pressure lower than 1 MPa (for example, 0.01 to 0.9 MPa) until the hydrogen gas is boosted in pressure by the electrochemical hydrogen compressor 20. That is, in each of the cathode 38, the cathode discharge flow path 68, and the first hydrogen gas flow path 78, the hydrogen-gas pressure is maintained at less than 1 MPa. Therefore, as described above, the flow rate of the hydrogen gas passing through the cathode discharge flow path 68, the water removal unit 18, and the first hydrogen gas flow path 78 and the generation amount of hydrogen gas generated in the booster cathode 88 are set to be sufficiently large in relation to the generation amount of hydrogen gas generated in the cathode 38.

Hereinafter, a process by which the oxygen gas generated in the anode 36 in the water electrolysis process fills the oxygen gas tank 32 will be described.

The oxygen gas generated in the anode 36 in the water electrolysis step is discharged from the oxygen discharge communication hole 60 to the anode discharge flow path 70. The oxygen gas discharged to the anode discharge flow path 70 is dehumidified by the oxygen gas dehumidifying unit 26 provided in the anode discharge flow path 70. That is, the oxygen gas dehumidifying unit 26 performs an oxygen gas dehumidifying step of removing water vapor contained in the oxygen gas discharged from the anode 36.

The oxygen gas discharge regulating unit 28 provided at the subsequent stage of the oxygen gas dehumidifying unit 26 of the anode discharge flow path 70 regulates passage of the oxygen gas through the oxygen gas discharge regulating unit 28. Thus, the oxygen gas discharge regulating unit 28 regulates the discharge of oxygen gas from the anode 36. In this manner, the oxygen gas discharge regulating unit 28 can adjust the oxygen gas pressure of the anode 36 by adjusting, for example, the passage amount of oxygen gas passing through the oxygen gas discharge regulating unit 28 with respect to the generation amount of oxygen gas generated in the anode 36.

To be specific, the oxygen gas discharge regulating unit 28 increases the oxygen gas pressure of the anode 36 to 1 MPa or higher. As described above, during operation of the water electrolysis system 10, the hydrogen gas pressure of the cathode 38 is maintained at less than 1 MPa. Therefore, the pressure of the oxygen gas at the anode 36 in the water electrolysis device 12 is maintained at a higher pressure than the pressure of the hydrogen gas at the cathode 38.

In the present embodiment, the oxygen gas discharge regulating unit 28 is a back pressure valve. Thus, the oxygen gas discharge regulating unit 28 opens the valve while maintaining the oxygen-gas pressure on the primary side (upstream) when the oxygen-gas pressure on the primary side (upstream) increases and reaches a set pressure set within a range of 1 to 100 MPa, for example. This makes it possible to maintain the anode 36 at a set pressure higher than that of the cathode 38, and the high-pressure oxygen gas whose pressure has been boosted to the set pressure can be supplied to the secondary side (downstream side) of the oxygen gas discharge regulating unit 28.

When the water electrolysis system 10 is started, the oxygen purge on-off valve 114 is closed and the oxygen on-off valve 108 is opened under the control of the control unit. Therefore, the high-pressure oxygen gas adjusted to the set pressure as described above passes through the oxygen on-off valve 108 and the oxygen check valve 110 without flowing into the oxygen purge flow path 112, and fills the oxygen gas tank 32. At this time, the oxygen check valve 110 prevents the oxygen gas from flowing back in the direction from the oxygen gas tank 32 toward the oxygen on-off valve 108.

As described above, the water electrolysis system 10 produces oxygen gas at the anode 36 of the water electrolysis device 12. In addition, the water electrolysis system 10 regulates the discharge of oxygen gas from the anode 36 by the oxygen gas discharge regulating unit 28. Thus, the water electrolysis system 10 can generate a differential pressure in the water electrolysis system 10 by increasing the pressure of the oxygen gas in the anode 36, and can produce high-pressure oxygen gas. The water electrolysis system 10 can charge the oxygen gas tank 32 with the produced high-pressure oxygen gas.

Hereinafter, an example of a control method when stopping the water electrolysis system 10 will be described. In this control method, a depressurizing step is performed. In the depressurizing step, the voltage applied to the water electrolysis device 12 by the power supply 16 is gradually reduced. In the depressurizing step, the hydrogen purge on-off valve 102 and the oxygen purge on-off valve 114 are opened. Thus, the hydrogen gas and the oxygen gas in the water electrolysis system 10 are gradually depressurized through the hydrogen purge flow path 100 and the oxygen purge flow path 112, respectively. At this time, in the first hydrogen gas flow path 78, the first hydrogen on-off valve 80 is in an open state. However, the first hydrogen check valve 82 prevents the hydrogen gas from flowing back from the electrochemical hydrogen compressor 20 toward the first hydrogen on-off valve 80.

By performing the depressurizing step as described above, it is possible to avoid occurrence of a rapid reaction change in the water electrolysis device 12. Accordingly, it is possible to suppress the occurrence of a potential difference in the same reaction surface of each unit cell 40. As a result, deterioration of the anode electrode catalyst layer, the cathode electrode catalyst layer, and the ion exchange membrane 34 can be effectively suppressed. For example, when the stop period of the water electrolysis system 10 is short, the depressurizing step may be omitted.

Before or after the depressurizing step, a shut-off step of closing each of the second hydrogen on-off valve 96 and the oxygen on-off valve 108 is performed. Thus, communication between the hydrogen gas tank 30 and the upstream side (water electrolysis device 12) of the second hydrogen gas flow path 92 from the second hydrogen on-off valve 96 is blocked. In addition, communication between the upstream side (water electrolysis device 12) of the anode discharge flow path 70 from the oxygen on-off valve 108 and the oxygen gas tank 32 is blocked.

In the depressurizing step, if the depressurizing speed is maintained at a predetermined speed at which the pressure can be reduced relatively slowly, crossover may easily occur in the ion exchange membrane 34. In this case, in order to avoid the crossover of the ion exchange membrane 34, each of the hydrogen purge on-off valve 102 and the oxygen purge on-off valve 114 is opened while the voltage application by the power supply 16 is maintained. In addition, the depressurization speed is maintained at a predetermined speed by adjusting the opening degree of each of the hydrogen purge on-off valve 102 and the oxygen purge on-off valve 114 and adjusting the pressure with each of the hydrogen gas discharge regulating unit 24 and the oxygen gas discharge regulating unit 28. Here, the predetermined speed is a depressurization speed at which a rapid reaction change in the water electrolysis device 12 can be avoided.

When there is no concern that crossover occurs in the ion exchange membrane 34 even if the depressurization speed in the depressurizing step is maintained at a predetermined speed, the voltage stopping step is performed. Alternatively, after the depressurizing step is performed while the voltage application by the power supply 16 is maintained as described above, the voltage stopping step is performed. In the voltage stopping step, after the application of the voltage to the water electrolysis device 12 by the power supply 16 is stopped, the application of the voltage to the electrochemical hydrogen compressor 20 by the booster power supply 90 is stopped.

In the present embodiment, in the voltage stopping step, the generation of hydrogen gas at the cathode 38 is stopped by stopping the application of voltage to the water electrolysis device 12 before stopping the application of voltage to the electrochemical hydrogen compressor 20. Accordingly, it is possible to suppress an increase in the pressure of the hydrogen gas in the cathode 38, the cathode discharge flow path 68, and the first hydrogen gas flow path 78. Therefore, it is possible to effectively prevent the hydrogen gas from flowing back in the direction from the electrochemical hydrogen compressor 20 toward the water electrolysis device 12. At this time, the reverse flow of the hydrogen gas in the direction from the electrochemical hydrogen compressor 20 toward the water electrolysis device 12 may be suppressed by closing the first hydrogen on-off valve 80.

In the voltage stopping step, when the reverse flow of the hydrogen gas can be sufficiently suppressed, the voltage application to the electrochemical hydrogen compressor 20 may be stopped after the voltage application to the water electrolysis device 12 is stopped.

After a state in which no current flows between the anode 36 and the cathode 38 of the water electrolysis device 12 is brought about by the voltage stopping step, the water supply stopping step is performed. In the water supply stopping step, the supply of water to the water electrolysis device 12 by the water supply unit 14 is stopped. Thereafter, it is confirmed that no current flows between the booster anode 86 and the booster cathode 88 of the electrochemical hydrogen compressor 20, and then the water electrolysis system 10 is brought into a stopped state.

As described above, in the water electrolysis system 10 according to the present embodiment, the oxygen gas discharge regulating unit 28 causes the pressure of the oxygen gas at the anode 36 to be higher than the pressure of the hydrogen gas at the cathode 38. This prevents hydrogen gas from permeating the ion exchange membrane 34 from the low-pressure cathode 38 toward the high-pressure anode 36. That is, the directionality (crossover directionality) in the case where the gas passes through the ion exchange membrane 34 can be fixed to (set to) the direction from the anode 36 side to the cathode 38 side. As a result, hydrogen gas generated at the cathode 38 can be prevented from entering the anode 36 side.

If the directionality of the crossover is not fixed, it is necessary to cope with both cases in which the hydrogen gas enters the anode 36 and in which the oxygen gas enters the cathode 38. On the other hand, by fixing (setting) the direction of the crossover as described above, it is possible to focus on the handling of the oxygen gas entering the cathode 38. As a result, it becomes easy to produce hydrogen gas and oxygen gas in a state of being well separated from each other.

Moreover, the oxygen gas having a larger molecular weight than the hydrogen gas is less likely to permeate the ion exchange membrane 34 than the hydrogen gas. Therefore, even if the directionality of the crossover is fixed as described above, it is possible to avoid a significant increase in the amount of oxygen gas permeating the ion exchange membrane 34 from the anode 36 toward the cathode 38. In addition, the solubility of oxygen gas in water is higher than that of hydrogen gas. Therefore, even if the oxygen gas generated in the anode 36 passes through the ion exchange membrane 34, the oxygen gas can be dissolved in the water present in the cathode 38 or the like of the water electrolysis device 12. Thus, it also becomes easy to produce hydrogen gas and oxygen gas in a state of being well separated from each other.

In the water electrolysis system 10 according to the embodiment described above, the water removal unit 18 is a gas-liquid separator that separates liquid water from hydrogen gas, and the water separated from the hydrogen gas by the water removal unit 18 is supplied to the water electrolysis device 12. In this case, the water separated in the water removal unit 18 can be used for water electrolysis in the water electrolysis device 12. Therefore, the utilization efficiency of water in the water electrolysis system 10 can be increased.

In the water electrolysis system 10 according to the above-described embodiment, the electrochemical hydrogen compressor 20 includes the booster proton exchange membrane 84, the booster anode 86 and the booster cathode 88 disposed so as to sandwich the booster proton exchange membrane 84 therebetween and isolated from each other, and the booster power supply 90 that applies a voltage to the booster anode 86 and the booster cathode 88. The electrochemical hydrogen compressor 20 is configured such that hydrogen gas and water vapor are supplied to the booster anode 86 and hydrogen gas having a pressure higher than a pressure of the hydrogen gas supplied to the booster anode 86 is discharged from the booster cathode 88.

In this case, as described above, the hydrogen gas can be electrochemically compressed by the electrochemical hydrogen compressor 20. Thus, in the water electrolysis system 10, it is possible to suppress the occurrence of noise, for example, as compared to a case where hydrogen gas is mechanically compressed using a compressor or the like. In addition, in the water electrolysis system 10, for example, it is possible to suppress an increase in the size of the electrochemical hydrogen compressor 20, compared to a case in which hydrogen gas is mechanically compressed using a compressor or the like. In the water electrolysis system 10, as described above, oxygen gas can also be compressed without using a compressor or the like. Thus, it is possible to effectively suppress the generation of noise when producing high-pressure gas and the increase in the size of the water electrolysis system 10.

As described above, hydrogen gas containing unreacted water (water vapor) is discharged from the water electrolysis device 12. Therefore, the hydrogen gas containing water vapor is supplied to the booster anode 86 of the electrochemical hydrogen compressor 20. In this case, the water vapor contained in the hydrogen gas can be used to keep the booster proton exchange membrane 84 in a wet state. As a result, the proton conductivity of the booster proton exchange membrane 84 can be favorably exhibited. Therefore, for example, it is not necessary to separately provide a humidifier or the like for humidifying the booster proton exchange membrane 84. Therefore, the water electrolysis system 10 can be further miniaturized and simplified in structure.

Further, in the electrochemical hydrogen compressor 20, the booster anode 86 and the booster cathode 88 disposed so as to sandwich the booster proton exchange membrane 84 therebetween are isolated from each other. The booster proton exchange membrane 84 selectively moves protons. Therefore, even if the oxygen gas is supplied to the booster anode 86 together with the hydrogen gas, the oxygen gas is prevented from moving toward the booster cathode 88. As a result, it is possible to prevent oxygen gas from being contained in the hydrogen gas discharged from the booster cathode 88.

In the water electrolysis system 10 according to the embodiment described above, the ion exchange membrane 34 is an anion exchange membrane. Anion exchange membranes generally have lower gas permeability and higher durability than proton exchange membranes. Therefore, by using the water electrolysis device 12 having the anion exchange membrane, the crossover between the anode 36 and the cathode 38 can be effectively suppressed. As a result, it becomes easier to obtain hydrogen gas and oxygen gas in a state of being separated from each other.

In the water electrolysis system 10 according to the embodiment described above, the water supply unit 14 supplies water to the cathode 38. In this case, it is not necessary to provide the anode 36, which is configured to increase the pressure of the oxygen gas in the water electrolysis device 12, with a configuration for enabling supply and discharge of water while maintaining the high pressure state. This makes it possible to simplify the configuration of the water electrolysis system 10. Even if the oxygen gas of the anode 36 permeates through the ion exchange membrane 34 and enters the cathode 38, water supplied from the water supply unit 14 exists in the cathode 38. Therefore, the oxygen gas can be effectively dissolved in the water in the cathode 38. As a result, it is possible to prevent oxygen gas from being contained in the hydrogen gas discharged from the cathode 38. As a result, in the water electrolysis system 10, it becomes easier to obtain hydrogen gas and oxygen gas in a state of being separated from each other.

The water electrolysis device 12 may be configured to supply water from the water supply unit 14 to the anode 36 instead of the cathode 38. Even in this case, the hydrogen gas can be generated in the cathode 38 and the oxygen gas can be generated in the anode 36 in the same manner as described embodiment. In addition, the water vapor contained in the hydrogen gas discharged from the cathode 38 can be used to maintain the booster proton exchange membrane 84 of the electrochemical hydrogen compressor 20 in a wet state.

The water electrolysis system 10 according to the embodiment described above further includes the oxygen gas dehumidifying unit 26 that dehumidifies the oxygen gas discharged from the water electrolysis device 12 (anode 36) and the hydrogen gas dehumidifying unit 22 that dehumidifies the hydrogen gas discharged from the electrochemical hydrogen compressor 20 (booster cathode 88). In this case, it is possible to prevent water vapor from being contained in each of the high-pressure hydrogen gas and the high-pressure oxygen gas produced by the water electrolysis system 10. In this way, since it is possible to prevent the water vapor from being contained in the high-pressure oxygen gas, it is possible to store a large amount of oxygen gas in the oxygen gas tank 32. In addition, since the high-pressure hydrogen gas can be prevented from containing water vapor, a large amount of hydrogen gas can be stored in the hydrogen gas tank 30.

The present invention is not particularly limited to the above-described embodiment, and various modifications can be made without departing from the scope of the invention.

What is claimed is:

1. A water electrolysis system including a water electrolysis device having an anode and a cathode which are disposed so as to interpose an ion exchange membrane therebetween and are isolated from each other, the water electrolysis device being configured to electrolyze water to thereby generate oxygen gas in the anode and generate hydrogen gas in the cathode, the water electrolysis system comprising:
a water supply unit configured to supply water to the water electrolysis device;
a power supply configured to apply a voltage to the anode and the cathode;
a water removal unit configured to separate water from the hydrogen gas discharged from the cathode;
an electrochemical hydrogen compressor configured to boost a pressure of the hydrogen gas from which the water has been separated by the water removal unit; and
an oxygen gas discharge regulating unit configured to regulate discharge of the oxygen gas generated in the anode, so that a pressure of the oxygen gas generated in the anode is higher than a pressure of the hydrogen gas generated in the cathode.

2. The water electrolysis system according to claim 1, wherein
the water removal unit is a gas-liquid separator configured to separate liquid water from hydrogen gas, and
the water separated from the hydrogen gas by the water removal unit is supplied to the water electrolysis device.

3. The water electrolysis system according to claim 1, wherein
the electrochemical hydrogen compressor includes a booster proton exchange membrane, a booster anode and a booster cathode disposed so as to interpose the booster proton exchange membrane therebetween, and a booster power supply configured to apply a voltage to the booster anode and the booster cathode,
the booster anode and the booster cathode are isolated from each other, and
the electrochemical hydrogen compressor allows hydrogen gas and water vapor to be supplied to the booster anode, and allows hydrogen gas having a pressure higher than that of the hydrogen gas supplied to the booster anode to be discharged from the booster cathode.

4. The water electrolysis system according to claim 1, wherein
the ion exchange membrane is an anion exchange membrane.

5. The water electrolysis system according to claim 1, wherein
the water supply unit supplies water to the cathode.

6. The water electrolysis system according to claim 1, further comprising:
an oxygen gas dehumidifying unit configured to dehumidify oxygen gas discharged from the water electrolysis device; and
a hydrogen gas dehumidifying unit configured to dehumidify hydrogen gas discharged from the electrochemical hydrogen compressor.
